(19) United States
(12) Patent Application Publication
(10) Pub. No.: US 2026/0259476 A1
(43) Pub. Date: Sep. 3, 2026

(54) CAMERA ARRAY WITH REDUCED CROSS-TALK

(71) Applicant: NIL Technology ApS, Kongens Lyngby (DK)

(72) Inventors: Niklas Hansson, Askim (SE); Martin Balimann, Zurich (CH)

(21) Appl. No.: 19/474,946

(22) PCT Filed: Apr. 19, 2024
(86) PCT No.: PCT/EP2024/060847

§ 371 Date: Oct. 13, 2025

Related U.S. Application Data
(60) Provisional application No. 63/497,040, filed on Apr. 19, 2023.

(51) Int. Cl. G03B 11/00

(52) U.S. Cl. CPC G03B 11/00

(57) ABSTRACT

An imaging device includes: an image sensor; a plurality of optical elements arranged in an array, each optical element being configured to direct light onto a different respective light sensitive region of the image sensor to capture a respective image; an aperture layer, wherein the aperture layer comprises a plurality of apertures that are arranged to align with the plurality of optical elements, respectively; and layer configured to reduce optical crosstalk within the imaging device.

### BACKGROUND

Array cameras can be based on arrays of lenses. The individual image produced by each lens in the array can in some cases be combined to produce an image that has higher resolution than the individual images.

### SUMMARY

This specification describes technologies relating to imaging devices such as array cameras including metalenses and in particular to array cameras designed to reduce the optical crosstalk between the lenses of the array.

In general, in some aspects, the subject matter of the present disclosure can be embodied in an imaging device comprising: an image sensor; a plurality of optical elements arranged in an array, each optical element being configured to direct light onto a different respective light sensitive region of the image sensor to capture a respective image; an aperture layer, wherein the aperture layer comprises a plurality of apertures that are arranged to align with the plurality of optical elements, respectively; and an optical filter layer positioned adjacent to the aperture layer, wherein the optical filter layer is configured to filter light having an angle of incidence that is outside of a predetermined field-of-view.

Implementations of the aspects may include one or more features. For example, in some implementations, the optical filter layer is positioned in front of the aperture layer such that the optical filter layer is nearer to an object to be imaged by the imaging device than the aperture layer. The optical filter layer may be positioned behind the aperture layer such that the optical filter layer is further from an object to be imaged by the imaging device than the aperture layer. The imaging device may include an additional optical filter layer, wherein the additional optical filter layer is positioned in front of the aperture layer such that the additional optical filter layer is nearer to an object to be imaged by the imaging device than the aperture layer. The optical filter layer may be fixed to the aperture layer.

In some implementations, each aperture of the plurality of apertures comprises a substantially rectangular opening through which incident light passes. Each optical element of the plurality of optical elements may have a substantially rectangular shape.

In some implementations, each optical element of the plurality of optical elements may be configured to distort incident light to project a corresponding substantially rectangular shaped image onto a respective light sensitive region of the image sensor. Each aperture of the of the plurality of apertures may include a substantially circular opening through which incident light passes.

In some implementations, each optical element of the plurality of optical elements arranged in the array comprises a metastructure. A phase shift induced by each optical element on light incident on the optical element may vary across an area of the optical element.

In some implementations, a size of at least one aperture of the plurality of apertures increases from a first side of the aperture layer to a second side of the aperture layer. The at least one aperture may include a conical shape. In some implementations, the optical filter is an interference filter. In some implementations, the optical filter layer is configured to function as a spectral filter layer.

In some implementations, the device includes a baffle. The baffle may include an opening positioned over at least one aperture of the aperture layer. The opening in the baffle layer may be larger than the at least one aperture. Sidewalls of the opening in the baffle layer may be arranged an oblique angle with respect to a normal of a surface of the aperture layer that faces an object to be imaged.

In some implementations, the imaging device includes a first spectral filter aligned with a first aperture of the plurality of apertures, wherein the first spectral filter is configured to filter light having wavelengths within a first wavelength range. The imaging device may include a second spectral filter aligned with the first aperture, wherein the second spectral filter is configured to filter light having wavelengths within a second wavelength range that is different from the first wavelength range.

In general, in some aspects, an imaging device includes: an image sensor; a plurality of optical elements arranged in an array, each optical element being configured to direct light onto a different respective light sensitive region of the image sensor to capture a respective image; an aperture layer, wherein the aperture layer comprises a plurality of apertures that are arranged to align with the plurality of optical elements, respectively; and a first spectral filter layer, wherein the first spectral filter layer comprises a first plurality of spectral filters aligned with the plurality of apertures, respectively, wherein each spectral filter of the first plurality of spectral filters is configured to filter a corresponding range of wavelengths. The imaging device may further include a second spectral filter layer, wherein the second spectral filter layer comprises a second plurality of spectral filters aligned the plurality of apertures, respectively, and wherein each spectral filter of the second plurality of spectral filters is configured to filter a corresponding range of wavelength.

In general, in some aspects, the subject matter of the present disclosure is embodied in imaging device comprising: an image sensor; a plurality of optical elements arranged in an array, each optical element being configured to direct light onto a different respective light sensitive region of the image sensor to capture a respective image; and an aperture layer, wherein the aperture layer comprises a plurality of apertures that are arranged to align with the plurality of optical elements, respectively, wherein the imaging device is configured to filter light having angles of incidence that is outside of a predetermined field-of-view from reaching the image sensor.

Implementations of the imaging device may include one or more of the following features. For example, the aperture layer may be configured to filter the light having angles of incidence that is outside of a predetermined field-of-view from reaching the image sensor. A size of at least one aperture of the plurality of apertures may increase from a first side of the aperture layer to a second side of the aperture layer. The at least one aperture may include a conical shape.

In some implementations, the device comprises a baffle layer. The baffle may comprise an opening positioned over at least one aperture of the aperture layer. The opening in the baffle layer may be larger than the at least one aperture. Sidewalls of the opening in the baffle layer may be arranged an oblique angle with respect to a normal of a surface of the aperture layer that faces an object to be imaged.

In some implementations, the device includes an optical filter layer positioned adjacent to the aperture layer, wherein the optical filter layer is configured to filter the light having an angle of incidence that is outside of a predetermined field-of-view. The optical filter layer may be positioned in front of the aperture layer such that the optical filter layer is nearer to an object to be imaged by the imaging device than the aperture layer. The optical filter layer may be positioned behind the aperture layer such that the optical filter layer is further from an object to be imaged by the imaging device than the aperture layer. The optical filter layer may be an interference filter. The optical filter layer also may be a spectral filter layer. The optical filter layer may comprise a first filter aligned with a first aperture of the aperture layer and comprises a second filter aligned with a second aperture of the aperture layer, wherein the first filter is configured to pass light having a first range of wavelengths and the second filter is configured to pass light having a second different range of wavelengths.

In some implementations, the imaging device includes a spectral filter layer, wherein the spectral filter layer comprises a first filter aligned with a first aperture of the aperture layer and comprises a second filter aligned with a second aperture of the aperture layer, wherein the first filter is configured to pass light having a first range of wavelengths and the second filter is configured to pass light having a second different range of wavelengths.

In some implementations, each aperture of the plurality of apertures comprises a substantially rectangular opening through which incident light passes. Each optical element of the plurality of optical elements may have a substantially rectangular shape. Each optical element of the plurality of optical elements may be configured to distort incident light to project a corresponding substantially rectangular shaped image onto a respective light sensitive region of the image sensor. Each optical element of the plurality of optical elements arranged in the array may be a metastructure.

Particular embodiments of the subject matter described in this specification can be implemented to realize one or more of the following advantages. The systems and techniques described herein can be used, in some implementations, to reduce or eliminate optical crosstalk between the optical elements of an optical element array. Further, the described techniques can provide, in some implementations, increased packing-density thus allowing greater use of sensor areas. By increasing the amount sensor area used, the systems and techniques described herein can, in some implementations, reduce the computational power required to generate a final image from the individual images generated by the camera array due to the reduced need for post processing. Accordingly, the systems described herein may provide high imaging performance at a reduced cost.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example of an array imaging device configuration for reducing optical crosstalk among the optical elements of the array imaging device.

FIGS. 2A-2C are schematics illustrating examples of components that can be used in an array imaging device.

FIGS. 3A-3C are schematics illustrating examples of components that can be used in an array imaging device.

FIG. 4A is a schematic that shows an example of an imaging device for reducing optical crosstalk.

FIG. 4B is a schematic that illustrates an example of an imaging device that includes both an aperture layer and a separate baffle layer.

FIG. 5 is a schematic that illustrates an example of an imaging device for reducing optical crosstalk.

Like reference numbers and designations in the various drawings indicate like elements. The shapes and dimensions of objects depicted in the figures are not necessarily to scale.

### DETAILED DESCRIPTION

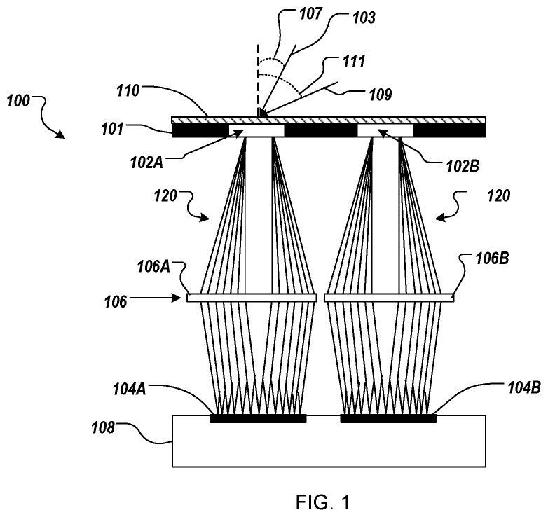

FIG. 1 shows an example of an array imaging device configuration (e.g., an array camera) for reducing optical crosstalk among the optical elements of the array imaging device. Array cameras can increase aperture area and overcome optical aberrations of single-lens cameras through producing multiple smaller images that are combined into a higher resolution image. An array camera can include an array of refractive lenses and/or an array of metastructures to produce the multiple smaller images, respectively. In some implementations, the array of refractive and/or metastructures are aligned with multiple apertures, respectively, through which incident light from an imaged object enters and then is incident on respective light sensitive regions of a corresponding image sensor. Optical crosstalk in such a device can be caused by light that enters the array camera through, e.g., a first aperture but is incident on a light sensitive area associated with a different aperture and/or is manipulated by an optical element or metastructure associated with a different aperture. This stray light can lead to an increase of the noise signal and thus hinder the performance of the array camera.

As shown in FIG. 1, an example of an imaging device (e.g., array camera) 100 includes an aperture layer 101 including multiple apertures (e.g., aperture 102A and aperture 102B). Although two apertures are shown, the aperture layer 101 can include additional apertures. Light from an object enters the apertures of the aperture layer 101 and passes through an optical element array 106. This light is shown as light rays 120 in FIG. 1. The aperture layer 101 can include, but is not limited to, a structure having a clear substrate (e.g., glass or plastic) on which is formed a patterned layer of material (e.g., chromium) that is reflective or absorptive of incident light. In the regions where the material is present, incident light will be reflected or absorbed. In regions where the material is absent, light may pass through the substrate.

The imaging device 100 further includes an optical element array 106. The optical element array 106 can include, e.g., an array of optical elements including lenses and/or an array of metastructures that focus the light rays 120 onto respective light sensitive portions 104A, 104B of an image sensor 108 of the imaging device 100. The optical elements can include flat optics (e.g., diffractive optical elements) or optics with curved surfaces. Light sensitive portions 104A, 104B can correspond to different sensors or to different portions of a same sensor. Although two light sensitive regions are shown, the light sensor can include additional light sensitive regions. Further, although a single image sensor is shown, multiple image sensors each having a respective light sensitive region may be used instead.

Metastructures have a metasurface, which refers to a surface with distributed small structures (e.g., meta-atoms) arranged to interact with light in a particular manner. For example, a metasurface can be a surface with a distributed array of nanostructures. The nanostructures are configured to interact, individually or collectively, with light waves so as to change a local amplitude, a local phase, or both, of an incoming light wave. When meta-atoms (e.g., nanostructures) of a metasurface are in a particular arrangement, the metasurface may act as an optical element such as a lens, lens array, beam splitter, diffuser, polarizer, bandpass filter, or other optical element. In some instances, metasurfaces may perform optical functions that are traditionally performed by refractive and/or diffractive optical elements. The meta-atoms may be arranged, in some cases, in a pattern so that the metastructure functions, for example, as a lens, grating coupler or other optical element. In other instances, the meta-atoms need not be arranged in a pattern, and the metastructure can function, for example, as a fanout grating, diffuser or other optical element. In some implementations, the metasurfaces may perform other functions, including polarization control, negative refractive index transmission, beam deflection, vortex generation, polarization conversion, optical filtering, and plasmonic optical functions.

Metasurfaces may have carefully arranged “unit cells” or “meta-atoms” with sub-wavelength structures (e.g., nanostructures). The term “subwavelength” indicates that the nanostructures have at least one lateral dimension (parallel to the substrate on which they are disposed) that is less than a wavelength of light that is to be incident thereon. The meta-atoms can be composed, for example, of silicon. In general, the dimensions of the nanostructures scale with the shortest wavelength of interest. For example, in some implementations, the nanostructures can be in the form of nanoscale features having dimensions less than 1 micron. By adjusting the geometry of these unit cell elements, one can modify the phase above the elements in response to a plane wave. With the knowledge of the phase in terms of the geometry parameters, it is possible to create a metalens with an arbitrary phase profile by placing the meta-atoms at the necessary positions. In general, the derivative of the phase profile determines the ray bending. Each substrate together with its respective metasurface forms a metalens.

Metastructures 106A, 106B can be supported by a glass or other substrate. The substrate may be composed, for example, of glass (e.g., borosilicate glass such as D 263® glass manufactured by Schott) and can be attached (e.g., bonded) to a metastructure (e.g., metastructures 106A, 106B) using an adhesive such as a polymer glue, that is optically clear at the operating wavelength (e.g., infrared or visible). In some implementations, the adhesive is index matched to the substrate. In some cases, the metastructure includes multiple metasurfaces that are stacked on one another. For example, in some implementations, a metastructure can include a substrate-metasurface-adhesive-metasurface-substrate stacking configuration or a substrate-metasurface-adhesive-substrate-metasurface stacking configuration. Incorporating a stack of metasurfaces into a metastructure arrangement can, in some instances, facilitate a wide range of optical functionalities by having a resonant interaction between the stacked metasurfaces. Such optical functionalities can include, for example, near-field interactions, filtering functions, and/or plasmonics.

In the example of FIG. 1, the array camera 100 further includes a field-of-view (FOV) filter 110 which only lets rays within a predetermined FOV pass through each aperture. For example, FOV filter 110 can reflect and/or absorb rays having an incident angle (as measured, e.g., with respect to a normal to the surface of the FOV filter 110) outside of a predetermined FOV value (e.g., 40 degrees) which, if not filtered, could cause optical crosstalk on adjacent lenses. The FOV filter 110 can include an interference filter. In the example, a first ray 103 has a first angle of incidence that is smaller than an angle of incidence 111 of a second ray 109. If the angle of incidence 111 is outside of the predetermined FOV, the FOV filter 110 may be configured to reflect and/or absorb the ray 111 so that it cannot pass through aperture 120A. Rays having angles of incidence within the predetermined FOV are not filtered by the FOV filter 110. The FOV filter 110 can be provided as a single continuous layer across the aperture layer 101 or alternatively can include multiple separate filter sub-layers that are arranged on the aperture layer 101. Each filter sub-layer can be arranged over a corresponding aperture of the aperture layer 101. Though shown as positioned above the aperture layer 101, the FOV filter 110 can be positioned beneath the aperture layer 101. In some implementations, two FOV filters can be used, with one positioned above the aperture layer 101, as shown in FIG. 1, and another positioned beneath the aperture layer 101. For narrow band illumination, the FOV filter(s) 110 may be constructed using interference filters. For instance, the interference filters may be formed from stacks of thin film material having refractive indexes that alternate between two values (e.g., between a first refractive index n1 and a second refractive index n2). The thin film stacks may be formed on a support substrate, such as a glass or plastic substrate. The interference filters may be designed for the specific parameters that are targeted. Alternatively, or in addition, the interference filter stack may be applied to the same substrate as used for the aperture layer 101. Thicknesses of the FOV filter 110 may be, e.g., greater than 50 microns, greater than 100 microns, or greater than 200 microns, among other thicknesses. In some implementations, the FOV filter 110 can be fixed to the aperture layer 101 using, e.g., an optical adhesive, or may be formed using thin film deposition processes.

The aperture layer 101 helps improve the image quality obtained by the imaging device 100. When the apertures within the aperture layer include circular openings, the light passing through the aperture layer towards the optical element array 106 would be substantially disc shaped. This, in turn, may result in a disc-like image projected towards the image sensor 108. In contrast, by introducing a substantially rectangular (including, e.g., square) imaging aperture or substantially rectangular baffle, the light towards the optical element array 106 would be closer to a rectangular shape and the projection on the image sensor 108 would also be closer to a rectangular shape. With substantially rectangular projections towards the sensor it is possible to maximize the packing density on the sensor.

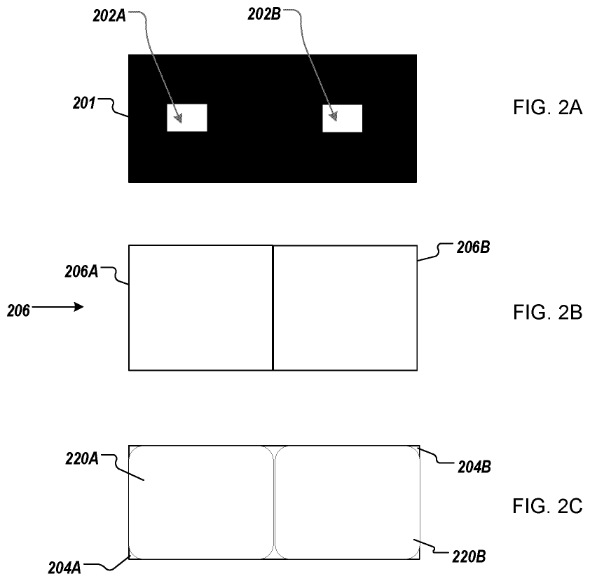

An example of using rectangular apertures is depicted in FIG. 2A. In particular, FIG. 2A illustrates a top view of an aperture layer 201 that includes multiple apertures (202A, 202B). The dark areas outside the apertures are opaque to incident light. The aperture layer 201 may be used as the aperture layer 101 in the imaging device depicted in FIG. 1. Although two apertures are shown, the aperture layer 201 can include additional apertures. Each aperture 202A, 202B of aperture layer 201 is constructed to have a generally rectangular (e.g., square) shape. The aperture layer 201 may also be referred to as a baffle layer or simply a baffle.

The apertures 202A, 202B of the aperture layer 201 may be aligned over corresponding optical elements of the optical element layer. FIG. 2B depicts a top view of an example optical element layer 206 that can be used with the aperture layer 201. The optical element layer 206 may be used as the optical element layer 106 in the imaging device 100 of FIG. 1. The optical element layer 206 includes multiple optical elements (e.g., elements 206A, 206B) that are each aligned with a respective aperture of the aperture layer 201. The optical elements 206A, 206B can include either lenses or metastructures. In order to use the rectangular apertures, the optical elements also should be rectangularly shaped (e.g., rectangular prisms). By forming the optical elements to have a rectangular shape, the packing density can be increased. That is, the optical elements 206A, 206B can be substantially adjacent, with substantially no gap between them to maximize their packing density.

The use of the rectangularly shaped apertures together with the rectangularly shaped optical elements produces generally rectangularly shaped images on the image sensor. With rectangularly shaped images, the light sensitive regions of the image sensor can also be rectangularly shaped, allowing for an increase in packing density of the image sensor. FIG. 2C depicts a top view of images produced on an image sensor using the rectangular apertures and rectangularly shaped optical elements. As shown in FIG. 2C, images 220A and 220B are substantially rectangular (with some rounded corners). Each image 220A, 220B is incident on a different respective light sensitive region 204A, 204B of an image sensor. The generally rectangular images are depicted close together with little or no gap space between them.

In general, it may be useful to avoid sharp corners for the rectangular apertures, as such features can lead to unwanted diffraction effects in the projected image. For this reason, in some cases, the rectangular apertures may be designed so that the radius of curvature of the aperture corners is greater than zero (where a radius of curvature equal to zero corresponds to a right angle at the corner). In some implementations, the radius of curvature may be, e.g., greater than 1 micron and less than 500 microns, such as greater than 5 microns and less than 200 microns, though other values may be used instead. In some implementations, the projected images produced using this technique may have no or little gap between adjacent images at the light sensitive regions (e.g., less than 50 microns, less than 10 microns, less than 5 microns, less than 1 micron, less than 0.5 microns). In some implementations, the adjacent projected images may overlap at the light sensitive regions of the image sensor. For instance, adjacent projected images may overlap by 0.5 microns, by 1 micron or by 2 microns. Other overlap distances are also possible.

In the present example, a single aperture layer is provided in which the apertures are rectangularly shaped. However, in some other implementations, an additional aperture layer may be provided that includes circular apertures aligned with the rectangular apertures of the aperture layer 201. The imaging aperture is a parameter that may be adjusted when designing the imaging device to obtain improved image performance. However, if the same aperture also is used to tailor packing density (how rectangular the image should be), the image performance may degrade. For that reason, instead of providing a single aperture layer, the additional aperture layer may be provided to adjust packing density of the projected images, whereas the original aperture layer may be used to adjust other properties of the projected image.

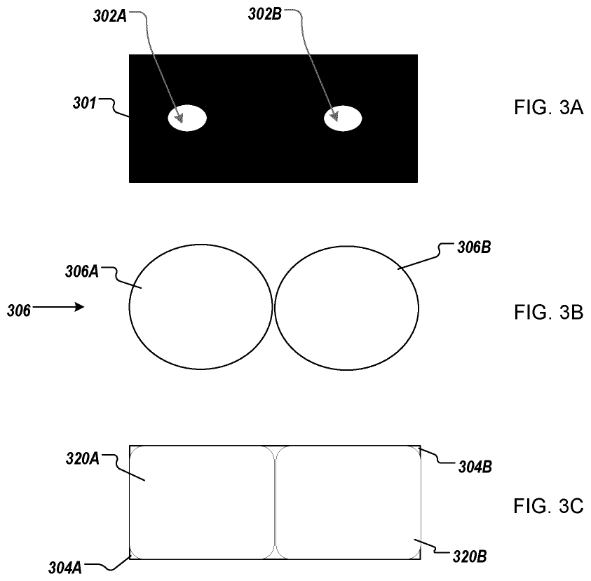

Although FIG. 2 depicts creating rectangular images through the use of rectangular apertures and corresponding rectangularly shaped optical elements, the rectangular images alternatively can be created as a result of deliberate distortion of an image. For instance, one or more optical elements (lens or metastructure) can be designed to create different phase functions across its area that result in distortion of the light passing through the optical element. In some cases, multiple optical elements are aligned with a corresponding aperture to introduce distortion in the light. The distorted light that is produced may have a generally rectangular shape, allowing for the packing density of the light sensitive regions of an image sensor to be increased. Alternatively, the distorted image may have a non-rectangular shape, but may still shaped by the distorted light so as to take up a larger portion of the sensor area, thus increasing packing density. An example of this is shown in FIGS. 3A-3C. Similar to FIG. 2A, FIG. 3C depicts an aperture layer 301 having multiple apertures 302A, 302B. In contrast to aperture layer 201, however, apertures 302A, 302B are circular or otherwise non-rectangular. Similarly, unlike optical element layer 206, the optical elements 306A, 306B of optical element layer 306 in FIG. 3B are circular or otherwise non-rectangular. However, the optical elements 306A, 306B are configured to exhibit different phase shifts across the area of the optical elements 306A, 306B in order to create distorted light. Depending on the specific amount of phase shift introduced at different portions of the optical elements 306A, 306B, distorted images (320A, 320B) may be produced that occupy larger portions of the light sensitive regions (304A, 304B) on the image sensor (see FIG. 3C).

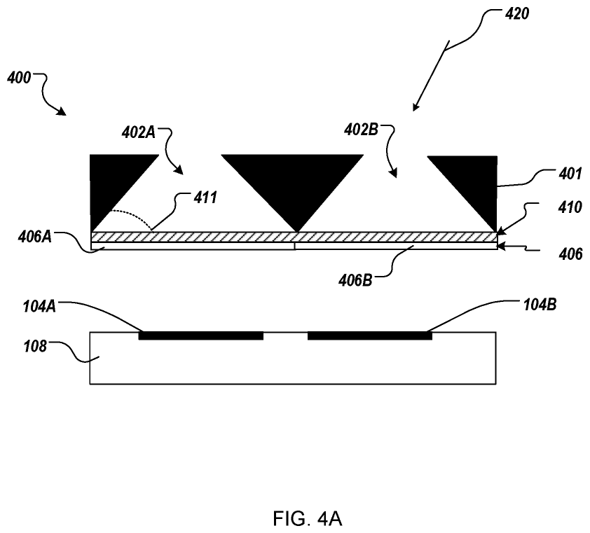

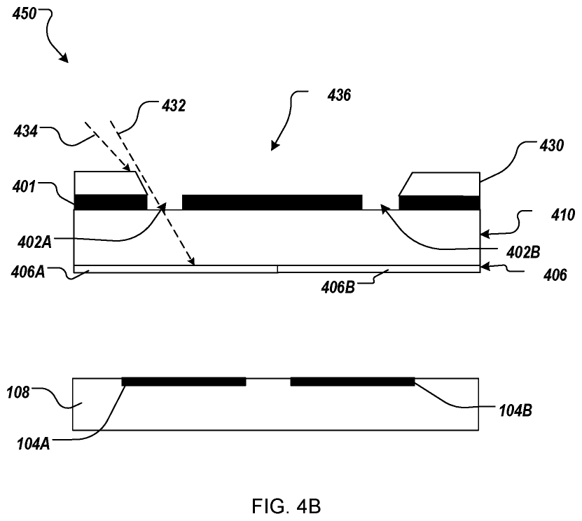

In some implementations, optical crosstalk can be reduced by modifying the shape of the apertures within the aperture layer. FIG. 4A is a schematic that shows an example of an imaging device 400 for reducing optical crosstalk. The imaging device includes an image sensor 108 having multiple light sensitive regions (e.g., 104A, 104B), an optical element layer 406 that includes multiple lenses and/or metastructures. In the present example, the optical elements 406A, 406B are depicted as metastructure layers. The imaging device 400 may optionally further include an optical filter 410, such as an FOV filter similar to that described with respect to FIG. 1, positioned in front of the optical element layer 406. The imaging device 400 also includes a baffle/aperture layer 401 positioned in front of the optical element layer 406 and the optional filter layer 410.

The aperture layer 401 includes multiple apertures (e.g., 402A, 402B) through which light (e.g., light ray 420) is incident. Unlike the apertures of aperture layer 101, the sidewalls of apertures 402A, 402B may be angled so as to block incident light having an angle of incidence that would otherwise result in optical crosstalk, e.g., light that has an angle of incidence outside a predetermined FOV.

For instance, the apertures 402A, 402B may have a conical shape. The cross-section of the conical shape shown in FIG. 4A exhibits sidewalls angled such that a size of the opening that forms the aperture increases from a first size at a front surface of the aperture layer 401 (e.g., facing the imaged object) to a larger opening at the back surface of the aperture layer 401 (e.g., facing the image sensor 108). The shape of the aperture may be substantially frustum conical or substantially frustrum pyramidal. The angle 411 of the sidewall may be adjusted to vary the range of incident angles that are blocked by the aperture layer 401. An advantage of designing the sidewalls to be obliquely angled rather than straight (i.e., perpendicular) is that in some implementations straight walls result in aperture designs that are required to be very thin, which can be difficult to manufacture. Apertures exhibiting the obliquely angled walls allow for greater thicknesses to be used.

In another example, a baffle separate from the aperture layer may be provided in the imaging device, in which the baffle includes one or more openings configured to prevent incident light outside the predetermined FOV from entering the wrong optical element of the optical element array. For instance, FIG. 4B is a schematic that illustrates an example of an imaging device that includes both an aperture layer 401 and a separate baffle layer 430. As before, the aperture layer 401 includes multiple apertures through which incident light can pass, and which are aligned with optical elements of an optical element layer 406. The optical element layer 406 can include an array of lenses or an array of metastructures. Metastructures 406A, 406B are shown in FIG. 4B but lenses may be used instead. The optical element layer 406 may be positioned above or below a filter layer 410. The filter layer 410 can include an FOV filter layer such as described herein.

The baffle layer 430 is positioned above the aperture layer 401. For instance, in some implementations, the baffle layer 430 is fixed to the aperture layer 401 through an optical adhesive. In the present case, because the number of apertures used is only two, the baffle layer 430 may include an opening area 436 that is larger (e.g., wider) than the apertures of the aperture layer 401, as it only needs to block incident rays directed towards adjacent optical elements. However, if more apertures are used, the baffle may be designed to block additional incident rays and thus have a smaller opening area. The opening area 436 of baffle may include angled sidewalls that allow light (e.g., light ray 432) having angles of incidence that are within a predetermined FOV to pass into the apertures of the aperture layer, but that also block light (e.g., light ray 434) that have angles of incidence that are outside of the predetermined FOV. For instance, the sidewalls of the opening area 436 may be arranged at an oblique angle with respect to a normal of the aperture layer surface that faces an object to be imaged. For instance, the angle of the sidewalls may be greater than 0 degrees with respect to the normal and less than 90 degrees with respect to the normal, e.g., greater than 5 degrees and less than 85 degrees, e.g., greater than 10 degrees and less than 80 degrees, e.g., greater than 20 degrees and less than 70 degrees.

In some implementations, optical crosstalk can be reduced using spectral filters. For instance, in some cases, a first light sensitive region of an image sensor may be configured to sense light having a first spectra (e.g., red light or blue light), and a second adjacent light sensitive region of the image sensor may be configured to sense light having a second different spectra (e.g., green light). Spectral filters then may be employed in front of each light sensitive region to prevent light of the wrong wavelength from reaching the light sensitive region.

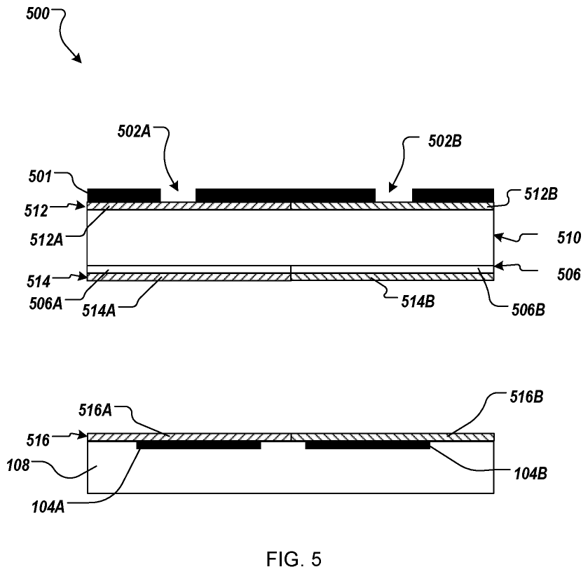

FIG. 5 is a schematic that illustrates an example of an imaging device 500 for reducing optical crosstalk caused by light of the wrong wavelength reaching an imaging region. The features described with respect to FIG. 5 may optionally be used in conjunction with any of the devices described with respect to FIGS. 1-4. The imaging device 500 includes an image sensor 108 having multiple light sensitive regions (e.g., regions 104A, 104B). The device 500 further includes an aperture layer 501 having multiple apertures (e.g., 502A, 502B). An optical element layer 506 may include an array of optical elements (e.g., an array of lenses or metastructures) that are aligned, respectively, with the apertures of the aperture layer 501. In the present example, the optical elements are depicted as metastructures, but lenses may additionally or alternatively be used. The imaging device 500 further includes an optional filter layer 510. The filter layer 510 may include an FOV filter, such as described herein.

The imaging device 500 may include optional spectral filter layers (e.g., 512, 514, 516). The spectral filter layers may include passband filters formed from stacks of thin films with alternating refractive indexes that are aligned with corresponding apertures of the aperture layer. The passband filters can be configured to allow only a particular wavelength or range of wavelengths to pass. In some implementations, there are at least two spectral filters aligned with each aperture (and thus multiple spectral filter layers). The at least two spectral filters may be configured to allow the same range of wavelengths to pass. In some implementations, spectral filters aligned with a first aperture are configured to pass a range of wavelengths that is different from the range of wavelengths that spectral filters aligned with a second aperture are configured to pass. In some implementations, the filter layer 510 doubles as both a FOV filter and a spectral filter as described herein. In those instances, the imaging device may include only one or no additional spectral filters aligned with each aperture.

In the example of FIG. 5, the optional first spectral filter layer 512 is positioned between the aperture layer 501 and the optional filter 510. The first spectral filter layer 512 may be fixed to the aperture layer and/or to the optional filter layer 510 using, e.g., an optical adhesive. The optional second spectral filter layer 514 may be positioned below the optical element layer 506. The optional second spectral filter layer 514 may be fixed to the optical elements of the optical element layer 506 using, e.g., an optical adhesive. The optional third spectral filter layer 516 may be positioned on the image sensor 108. The optional third spectral filter layer 516 may be fixed to the image sensor using, e.g., an optical adhesive. Though the spectral filter layers 512, 514, 516 are shown in particular positions with respect to other components, other arrangements are also possible. For instance, the first spectral filter layer 512 may be positioned beneath the optional filter 510, or positioned in front of the aperture layer 501, or positioned in front of the optical element layer 506, but behind the optional filter 510. The spectral filter layers can be formed on separate substrates or applied on other substrates in the imaging device 500.

Each spectral filter layer may include multiple spectral filters. In the present example, the first spectral filter layer 512 includes a first spectral filter 512A and a second spectral filter 512B, though layer 512 may include more spectral filters. The first spectral filter 512A may be aligned with the first aperture 502A of the aperture layer 501. The first spectral filter 512A may be configured to filter out light having wavelengths that is not intended to reach first light sensitive region 104A. For instance, first light sensitive region 104A may be configured to or provided for detecting a first range of wavelengths (e.g., red light). Accordingly, the first spectral filter 512A may be configured to filter out light that is outside of the red wavelength band. For instance, the first spectral filter 512A may be configured to filter out blue light, green light or blue and green light.

Similarly, the second spectral filter 512B of the first spectral filter layer 512 may be aligned with the second aperture 502A of the aperture layer 501. The second spectral filter 512B may be configured to filter out light having wavelengths that are not intended to reach second light sensitive region 104B. For instance, second light sensitive region 104B may be configured to or provided for detecting a second range of wavelengths (e.g., blue light). Accordingly, the second spectral filter 512B may be configured to filter out light that is outside of the blue wavelength band. For instance, the second spectral filter 512B may be configured to filter out green light, red light or red and green light.

The second spectral filter layer 514 may also include multiple spectral filters. In the present example, the second spectral filter layer 514 includes a first spectral filter 514A and a second spectral filter 514B, though layer 514 may include more spectral filters. The first spectral filter 514A may be aligned with the first aperture 502A of the aperture layer 501. The first spectral filter 514A may be configured to filter out light having a range of wavelengths that are not intended to reach first light sensitive region 104A. For instance, first light sensitive region 104A may be configured to or provided for detecting a first range of wavelengths (e.g., red light). Accordingly, the first spectral filter 514A may be configured to filter out light that is outside of the red wavelength band. If the first spectral filter 514A and the first spectral filter 512A are both used, then each filter may be configured to filter out a different range of wavelengths or a same range of wavelengths. For instance, the first spectral filter 512A may be configured to filter out blue light, whereas the first spectral filter 514A may be configured to filter out green light or vice versa.

Similarly, the second spectral filter 514B may be aligned with the second aperture 502A of the aperture layer 501. The second spectral filter 514B may be configured to filter out light having a range of wavelengths that is not intended to reach second light sensitive region 104B. For instance, second light sensitive region 104B may be configured to or provided for detecting a second range of wavelengths (e.g., blue light). Accordingly, the second spectral filter 514B may be configured to filter out light that is outside of the blue wavelength band. If the second spectral filter 514B and the second spectral filter 512B are both used, then each filter may be configured to filter out a different range of wavelengths or a same range of wavelengths. For instance, the second spectral filter 512B may be configured to filter out red light, whereas the second spectral filter 514B may be configured to filter out green light or vice versa.

The third spectral filter layer 516 may also include multiple spectral filters. In the present example, the third spectral filter layer 516 includes a first spectral filter 516A and a second spectral filter 516B, though layer 516 may include more spectral filters. The first spectral filter 516A may be aligned with the first aperture 502A of the aperture layer 501. The first spectral filter 516A may be configured to filter out light having a range wavelengths that is not intended to reach first light sensitive region 104A. For instance, first light sensitive region 104A may be configured to or provided for detecting a first range of wavelengths (e.g., red light). Accordingly, the first spectral filter 516A may be configured to filter out light that is outside of the red wavelength band. If the first spectral filter 516A and the first spectral filters 512A, 514A are all used, then each filter may be configured to filter out a different range of wavelengths or the same range of wavelengths. For instance, the first spectral filter 516A may be configured to filter out blue light, whereas the first spectral filter 514A may be configured to filter out green light, and the first spectral filter 512A may be configured to filter out a combination of green and blue light.

Similarly, the second spectral filter 516B may be aligned with the second aperture 502A of the aperture layer 501. The second spectral filter 516B may be configured to filter out light having a range of wavelengths that is not intended to reach second light sensitive region 104B. For instance, second light sensitive region 104B may be configured to or provided for detecting a second range of wavelengths (e.g., blue light). Accordingly, the second spectral filter 516B may be configured to filter out light that is outside of the blue wavelength band. If the second spectral filter 516B and the second spectral filters 514B, 512B are all used, then each filter may be configured to filter out a different range of wavelengths or the same range of wavelengths. For instance, the second spectral filter 516B may be configured to filter out red light, whereas the second spectral filter 514B may be configured to filter out green light, and the second spectral filter 512B may be configured to filter out green and red light.

As explained above, in some implementations, the imaging device may employ a filter layer that is configured to function as both a FOV filter for filtering out incident light having incident angles outside of a predetermined FOV and to function as a spectral filter. For instance, instead of imaging device 500 including layers 512, 514, and 516, the device may include a single filter layer 510 that performs the functions of a FOV filter and a spectral filter. In some implementations, the imaging device may employ a filter layer (e.g., 510 or 512) that functions as a FOV filter and a spectral filter, and include a second additional layer that also functions as an additional FOV filter and/or an additional spectral filter. In some implementations, the imaging device employs two or more filter layers (e.g., 512, 514), each of which includes multiple filters aligned with multiple apertures, respectively, but does not include the optical filter 510.

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments.

Thus, particular embodiments of the invention have been described. Other embodiments are within the scope of the following claims. In addition, actions recited in the claims can be performed in a different order and still achieve desirable results.

1. An imaging device comprising:
an image sensor;
a plurality of optical elements arranged in an array, each optical element being configured to direct light onto a different respective light sensitive region of the image sensor to capture a respective image;
an aperture layer, wherein the aperture layer comprises a plurality of apertures that are arranged to align with the plurality of optical elements, respectively; and
an optical filter layer positioned adjacent to the aperture layer, wherein the optical filter layer is configured to filter out light having an angle of incidence that is outside of a predetermined field-of-view.

2. The imaging device of claim 1, wherein the optical filter layer is positioned in front of the aperture layer such that the optical filter layer is nearer to an object to be imaged by the imaging device than the aperture layer.

3. The imaging device of claim 1, wherein the optical filter layer is positioned behind the aperture layer such that the optical filter layer is further from an object to be imaged by the imaging device than the aperture layer.

4. The imaging device of claim 3, comprising an additional optical filter layer, wherein the additional optical filter layer is positioned in front of the aperture layer such that the additional optical filter layer is nearer to the object to be imaged by the imaging device than the aperture layer.

5. The imaging device of claim 1, wherein the optical filter layer is fixed to the aperture layer.

6. The imaging device of claim 1, wherein each aperture of the plurality of apertures comprises a substantially rectangular opening through which incident light passes.

7. The imaging device of claim 6, wherein each optical element of the plurality of optical elements has a substantially rectangular shape.

8. The imaging device of claim 1, wherein each optical element of the plurality of optical elements is configured to distort incident light to project a corresponding substantially rectangular shaped image onto a respective light sensitive region of the image sensor.

9. The imaging device of claim 8, wherein each aperture of the of the plurality of apertures comprises a substantially circular opening through which incident light passes.

10. The imaging device of claim 1, wherein each optical element of the plurality of optical elements arranged in the array comprises a metastructure.

11. The imaging device of claim 1, wherein the optical filter layer comprises an interference filter.

12. The imaging device of claim 1, wherein a size of at least one aperture of the plurality of apertures increases from a first side of the aperture layer to a second side of the aperture layer.

13. The imaging device of claim 12, wherein the at least one aperture comprises a conical shape.

14. The imaging device of claim 1, wherein the optical filter layer is configured to function as a spectral filter layer.

15. The imaging device of claim 14, wherein the optical filter layer comprises at least two filters aligned with a first aperture of the plurality of apertures and comprises at least two filters aligned with a second aperture of the plurality of apertures, wherein the at least two filters aligned with the first aperture are configured to pass light having a first range of wavelengths and the at least two filters aligned with the second aperture are configured to pass light having a second range of wavelengths, the second range different from the first range.

16. The imaging device of device of claim 15, comprising:
a third filter aligned with the first aperture, wherein the third filter aligned with the first aperture is configured to pass light having the first range of wavelengths; and
a third filter aligned with the second aperture, wherein the third filter aligned with the second aperture is configured to pass light having the second range of wavelengths.

17. The imaging device of claim 16, wherein a first filter aligned with the first aperture is positioned adjacent to the aperture layer and in front of a second filter aligned with the first aperture, the second filter aligned with the first aperture is positioned adjacent to a first optical element of the plurality of optical elements, and the third filter aligned with the first aperture is positioned adjacent to a first light sensitive region of the image sensor, and
wherein a first filter aligned with the second aperture is positioned adjacent to the aperture layer and in front of a second filter aligned with the second aperture, the second filter aligned with the second aperture is positioned adjacent to a second optical element of the plurality of optical elements, and the third filter aligned with the second aperture is positioned adjacent to a second light sensitive region of the image sensor.

18.-21. (canceled)

22. An imaging device comprising:
an image sensor;
a plurality of optical elements arranged in an array, each optical element being configured to direct light onto a different respective light sensitive region of the image sensor to capture a respective image; and
an aperture layer, wherein the aperture layer comprises a plurality of apertures that are arranged to align with the plurality of optical elements, respectively,
wherein the imaging device is configured to filter light having angles of incidence that is outside of a predetermined field-of-view from reaching the image sensor.

23. The imaging device of claim 22, wherein the aperture layer is configured to filter the light having angles of incidence that is outside of a predetermined field-of-view from reaching the image sensor.

24.-42. (canceled)
